(19) United States
(12) Patent Application Publication
(10) Pub. No.: US 2014/0059667 A1
(43) Pub. Date: Feb. 27, 2014

(54) IMAGE EXCHANGE METHOD AND SYSTEM FOR REMOTE SUPPORT

(71) Applicant: RSupport Co., Ltd, Seoul (KR)

(72) Inventor: Hyung Su Seo, Gyeonggi-do (KR)

(73) Assignee: RSUPPORT CO., LTD, Seoul (KR)

(21) Appl. No.: 13/971,568

(22) Filed: Aug. 20, 2013

(30) Foreign Application Priority Data
Aug. 23, 2012 (KR) 10-2012-0092410

(51) Int. Cl. H04L 29/06

(52) U.S. Cl. CPC H04L 63/0281
USPC 726/12

(57) ABSTRACT

An image exchange method and system for remote support that can effectively provide remote support are provided. A manager terminal, after completing authentication through an authentication server, connects to a gateway server. A user terminal executes an application and receives gateway server connection information from the authentication server through a password input, connects to the gateway server based on the gateway server connection information, and transmits an image to the manager terminal. Accordingly, the manager can diagnose a problem regarding which the user has requested support, in real-time through the image, and the user can receive remote support through an image from the manager, thereby avoiding unnecessary costs.

### CLAIM FOR PRIORITY

This application claims priority to Korean Patent Application No. 10-2012-0092410 filed on Aug. 23, 2012 in the Korean Intellectual Property Office (KIPO), the entire contents of which are hereby incorporated by reference.

### BACKGROUND OF INVENTION

1. Technical Field

Example embodiments of the present invention relate in general to the field of an image exchange method and system, and more specifically, to an image exchange method and system for remote support that can effectively provide remote support.

2. Related Art

Development of information & communication technology has brought great changes to the way people live. Specifically, the proliferation and development of the Internet has led to economic, cultural and political innovations, such as new business models based on knowledge and information summarized as transactions and e-business, revitalization of a cyber world through information sharing, new media replacing newspapers and conventional broadcasting, and so on.

Through the widespread proliferation of the Internet and the development of mobile communications technology, a wireless terminal is no longer a simple communication means but rather is capable of accessing the Internet anytime and anywhere. A user of the wireless terminal can move freely to any place he wants while maintaining a connection to a network.

Meanwhile, through the development of information and communication technology, many electronic products have been produced and used by users.

Since many electronic products are used, requests for repairs due to malfunction of the electronic products are a growing trend.

In general, when an electronic product malfunctions, the user makes a call to an after service (A/S) center, or requests a visit from a repair technician, in order to repair the malfunction. A visit may become necessary if the malfunction of the electronic product is not repaired.

However, even if a malfunction is simple, since the user may be unskilled in handling the electronic product, or may fail to properly explain how the electronic product is malfunctioning, there are frequently cases in which a technician has to visit the user's home.

Accordingly, even if the malfunction is simple, if the manager fails to solve the malfunction by phone, and has to visit the user's home, his work load increases.

Further, from the user's point of view, having a technician come out to fix a simple malfunction may be unnecessarily costly, due to incurred travel expenses, a repair cost, etc.

### SUMMARY OF INVENTION

Accordingly, example embodiments of the present invention are provided to substantially obviate one or more problems due to limitations and disadvantages of the related art.

Example embodiments of the present invention provide an image exchange method for remote support that can effectively provide remote support.

Example embodiments of the present invention also provide an image exchange system for remote support that can effectively provide remote support.

In one general aspect, an image exchange method for remote support which is performed in a manager terminal includes: requesting an authentication server for authentication; receiving connection information of a gateway server from the authentication server; connecting to the gateway server based on the received connection information of the gateway server and waiting for remote connection with a user terminal; and if the remote connection with the user terminal is established, receiving an image from the user terminal through the gateway server.

After the receiving of the image from the user terminal through the gateway server, the method may further include: indicating at least one among an input marking, a picture, and a check on the received image, and transmitting an image on which the at least one among the input marking, the picture, and the check is indicated to the user terminal.

The requesting of the authentication server for authentication may include transmitting authentication information including at least one of an identification (ID) and a password based on a manager input signal to the authentication server.

The image may be an image of an object captured in real-time using the user terminal.

After the receiving of the connection information of the gateway server, the method may further include: transmitting information on a location from which an application for remote support can be downloaded by a least one method among a message and an e-mail to the user terminal.

In another aspect, an image exchange method for remote support which is performed in a user terminal includes: launching an application; requesting an authentication server for authentication through the launched application; receiving gateway server connection information corresponding to the authentication request from the authentication server; connecting to a gateway server based on the gateway server connection information; and transmitting an image captured in real-time to a manager terminal with which a remote connection is established through the gateway server.

Before launching the application, the method may further include: receiving information on a location from which an application for remote support can be downloaded from the manager terminal by a least one method among a message and an e-mail.

The requesting the authentication server for the authentication through the launched application may include transmitting a password input by a user to the authentication server.

The receiving of the connection information of a gateway server corresponding to the authentication server may include receiving information including at least one among an IP address and a Port Number of the gateway server from the authentication server.

The transmitting of the image captured in real-time to the manager terminal with which the remote connection is established through the gateway server, if the remote connection with the manager terminal is established, may include executing a speaker phone function by the user terminal.

After the transmitting of the image captured in real-time to the manager terminal with which the remote connection is established through the gateway server, the method may further include: receiving an image on which at least one among the input marking, the picture, and the check is indicated, from the manager terminal.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram showing an operating environment of an image exchange system for remote support according to an exemplary embodiment of the present invention.

FIG. 2 is a flowchart showing an image exchange process for remote support according to an exemplary embodiment of the present invention.

FIG. 3 is a flowchart showing an image exchange process for remote support according to an exemplary embodiment of the present invention.

FIG. 4 is a flowchart showing an image exchange method for remote support performed in a user terminal according to an exemplary embodiment of the present invention.

### DETAILED DESCRIPTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, in an embodiment of the present invention, a manager terminal 100 may be not only a desktop computer but also various digital information processing apparatuses including a notebook computer, a palmtop computer, a UMPC (Ultra Mobile Personal Computer), a tablet PC, a PDA (Personal Digital Assistant), a Web Pad, a handheld phone, and so on.

Further, in an embodiment of the present invention, a user terminal 500 may be a mobile communication terminal apparatus such as a smart phone, a hand phone, a PDA, and so on, and also various digital information processing apparatuses such as a PMP (Portable Multimedia Player), a smart player, a pad-type terminal apparatus, and so on.

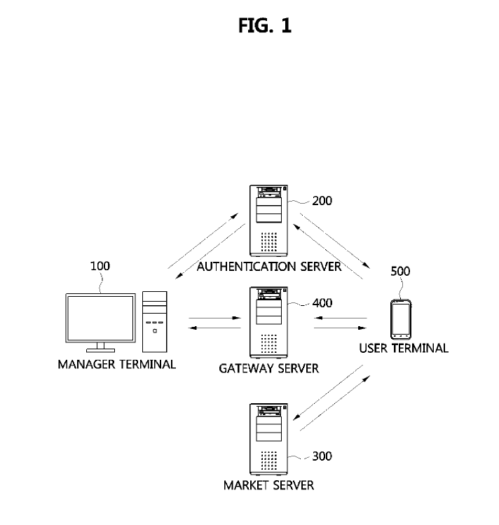

FIG. 1 is a conceptual diagram showing an operating environment of an image exchange system for remote support according to an exemplary embodiment of the present invention.

Referring to FIG. 1, the image exchange system for remote support may include a manager terminal 100, an authentication server 200, a market server 300, a gateway server 400, and a user terminal 500.

First, the manager terminal 100 may complete authentication through the authentication server 200 and receive gateway server connection information and a password from the authentication server 200.

Further, the manager terminal 100 may connect to the gateway server 400 based on the gateway server connection information and wait for connection of the user terminal 500.

Moreover, the manager terminal 100 may transmit location information from which the user terminal 500 can download an application for remote support, and a password for the user terminal 500 to perform authentication with the authentication server 200, to the user terminal 500.

Here, according to the above description of an embodiment of the present invention, the manager terminal 100 may transmit the password with which the user terminal 500 can perform authentication with the authentication server 200 to the user terminal 500. However, in another embodiment of the present invention, the manager terminal 100 may provide the password with which the user terminal 500 can perform authentication with the authentication server 200 to the user through voice.

Further, the manager terminal 100, when a session connection with the user terminal 500 is established, may receive an image captured in real-time by the user terminal 500 through the gateway server 400.

The authentication server 200 may receive an authentication request from the manager terminal 100, if authentication is successful, and generate gateway server connection information and a password to transmit to the manager terminal 100.

Further, when there is an authentication request from the user terminal 500 and the password is confirmed, the authentication server 200 may transmit the gateway server connection information to the user terminal 500.

When there is an application request from the user terminal 500, the market server 300 may transmit corresponding application to the user terminal 500.

The gateway server 400, after establishing a connection with the manager terminal 100 or the user terminal 500, may intermediate data transmission between the manager terminal 100 and the user terminal 500 which are connected by the same or corresponding gateway server information.

The user terminal 500 may receive information on a location from which an application for remote support can be downloaded and a password from the manager terminal 100, connect to the market server 300 based on the market server information, and download the application for remote support.

After that, the user terminal 500 may execute the downloaded application based on a user input signal, input the password received from the manager terminal 100 based on the user input signal, and request authentication with the authentication server 200.

Further, the user terminal 500 may connect to the gateway server 400 based on the gateway server information, and complete a connection with the manager terminal 100.

Moreover, the user terminal 500 may transmit an image being captured in real-time by the user terminal 500 to the manager terminal 100 through the gateway server 400.

According to an image exchange system for remote support of an embodiment of the present invention, there is no need for identification (ID) for remote support between the manager terminal 100 and the user terminal 500, and no need to use a telephone number. Further, when remote support is needed, the user terminal 500 may temporarily download the application and receive remote support. When remote support is finished, the user terminal 500 may delete the application. Moreover, even if the identification of the user terminal is not included in the application for remote support, the manager terminal can still easily provide remote support.

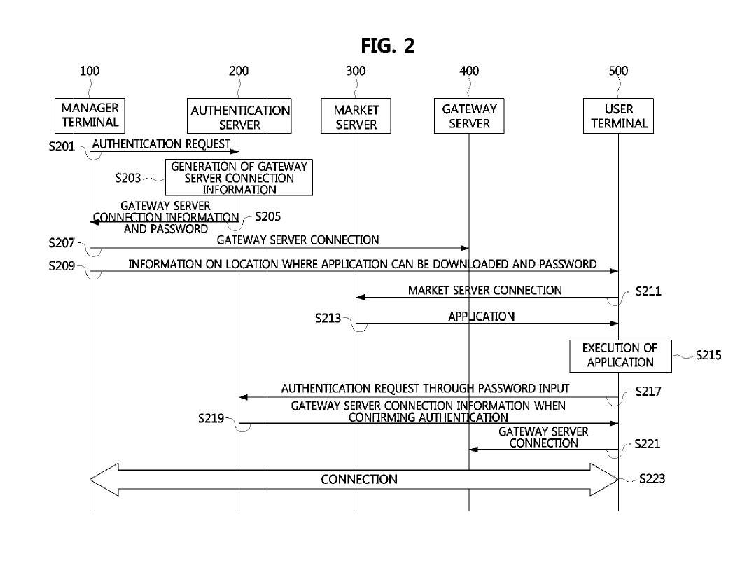

FIG. 2 is a flowchart showing an image exchange process for remote support according to an exemplary embodiment of the present invention.

Referring to FIG. 2, the manager terminal 100 may request authentication server 200 for authentication based on information input by a manager (S201).

Here, the information input by the manager may be an identification (ID), a password, and so on, which have been previously stored in the authentication server 200.

When there is an authentication request from the manager terminal 100 in step S201, the authentication server 200 may determine whether the input information corresponds to the previously stored information. If the input information corresponds to the previously stored information, the authentication server 200 may generate gateway server connection information and a password (S203).

Here, the gateway server connection information may include an IP address, a port number, and so on of the gateway. Further, the password means information transmitted to the authentication server 200 after launching an application so that the user terminal 500 receives the same gateway connection information as the manager terminal 100

Next, the authentication server 200 may transmit the generated gateway server connection information and the password to the manager terminal 100 (S205).

The manager terminal 100 may receive the gateway server connection information and the password from the authentication server 200 in step S205, and connect to the gateway server 400 based on the received gateway server connection information (S207).

The manager terminal 100 may transmit information on a location from which an application for remote support can be downloaded and the password received from the authentication server 200 to the user terminal 500 (S209).

Here, the manager terminal 100 may perform an operation of transmitting the location information and the password received from the authentication server 200 to the user terminal 500 through a message (SMS, MMS, etc.), an e-mail, and so on.

The user terminal 500 may connect to the market server 300 based on the location information obtained in step S209 (S211), and download the application for remote support from the market server 300 (S213).

Next, the user terminal 500 may execute the downloaded application based on a user input signal (S215), and submit an authentication request to the authentication server 200 (S217).

Here, an operation of requesting authentication with the authentication server 200 may be performed since the user terminal 500 transmits the password input based on the user input signal to the authentication server 200.

When there is an authentication request from the user terminal 500 and information corresponding to the input password is confirmed, the authentication server 200 may transmit the same gateway server connection information that has been provided to the manager terminal 100 to the user terminal 500 (S219).

The user terminal 500 may connect to the gateway server 400 based on the gateway server connection information received from the authentication server 200 (S221), and a connection between the user terminal 500 and the manager terminal 100 may be established in step S221 (S223).

Accordingly, when the connection with the manager terminal 100 is established, the user terminal 500 can transmit an image captured in real-time by the user terminal 500 to the manager terminal 100 through the gateway server 400, and receive reliable remote support.

Further, after receiving the image through the gateway server 400, the manager terminal 100 may transmit an image indicating information input by a manager on the image received through the gateway server 400 to the user terminal 500 through the gateway server 400. Accordingly, the manager terminal 100 can provide reliable remote support.

Here, the image indicating the information input from the manager may be an image indicating a marking, a picture, a check, and so on input from the manager on the image received through the gateway server 400. The marking, the picture, the check, and so on input from the manager are made to be easy for the user to recognize through the user terminal 500, and there is no limitation on a method of making the marking, the picture, the check, and so on.

In the image exchange method for remote support according to an embodiment of the present invention, as described above, the manager terminal 100 may connect to the authentication server 200, receive the password, and transmit the password to the user terminal 500. However, in another embodiment of the present invention, the user terminal 500 may connect to the authentication server 200, receive the password, and transmit the password to the manager terminal 100. Accordingly, the manager terminal 100 may connect to the authentication server 200 based on the password received from the user terminal 500, and receive the gateway server connection information.

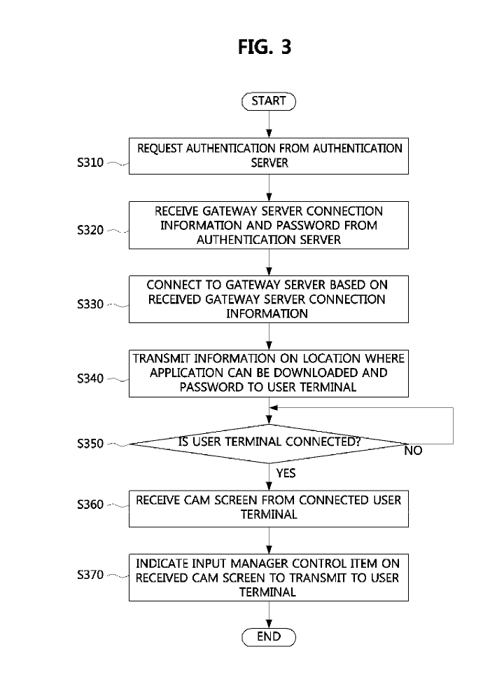

FIG. 3 is a flowchart showing an image exchange process for remote support according to an exemplary embodiment of the present invention.

Referring to FIGS. 1 and 3, if a previously installed program is executed, the manager terminal 100 may transmit manager identification information to the authentication server 200 and request authentication (S310).

Here, the manager identification information may be a manager identification (ID), a password, etc., which has been previously stored in the authentication server 200.

When authentication is completed, the manager terminal 100 may receive gateway server connection information and a password from the authentication server 200 (S320).

Here, the gateway server connection information may be a gateway IP address, a port number, and so on.

The manager terminal 100 may connect to the gateway server 400 based on the gateway server connection information received in step S320 (S330).

Further, the manager terminal 100 may transmit information on a location from which an application for remote service can be downloaded and the password received in step S320 to the user terminal 500, in order that the user terminal 500 can download the application for remote support through image exchange (S340).

Here, the manager terminal 100 may transmit the downloadable location information and the password to the user terminal 500 through a message (SMS, MMS, etc.), an e-mail, and so on.

Next, the manager terminal 100 may determine whether a connection between the user terminal 500 and the gateway server 400 is established (S350), and if the connection is established, may receive an image from the user terminal 500 through the gateway server 400 (S360).

After the manager terminal 100 indicates a problem portion based on manager control information input on the image received in step S360, the manager terminal 100 may transmit the image indicating the problem to the user terminal 500 (S370).

According to the image exchange method for remote support of an embodiment of the present invention, a manager can diagnose a problem for which the user has requested remote support through the image, and the user can easily follow directions from the manager by indicating what has to be done on the image. Accordingly, the manager can easily provide remote support, and the user can easily receive remote support without unnecessary cost.

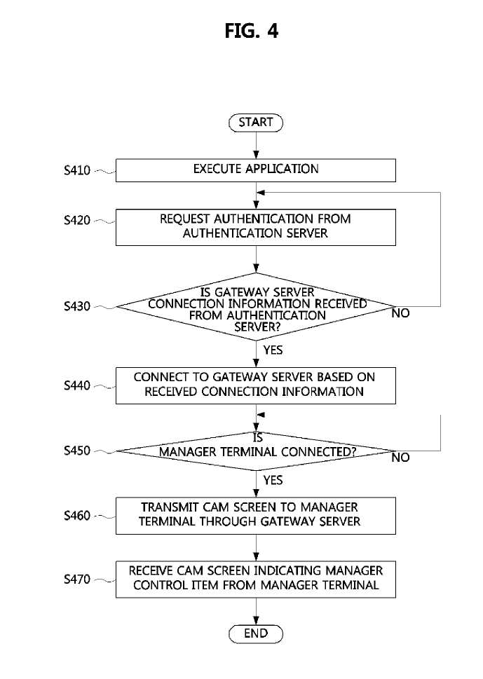

FIG. 4 is a flowchart showing an image exchange method for remote support performed in a user terminal according to an exemplary embodiment of the present invention.

Referring to FIGS. 1 and 4, the user terminal 500 may execute the downloaded application in order to receive remote support (S410).

The user terminal 500, after launching the application in step S410, may request authentication with the authentication server 200 (S420).

Here, the user terminal 500, after launching the application, may input a password received from the manager terminal 100 based on a user input control signal and request authentication.

The user terminal 500 may determine whether gateway server connection information is received from the authentication server 200 (S430). If it determines that the gateway server connection information is received, the user terminal 500 may connect to the gateway server 400 based on the gateway server connection information (S440).

Next, the user terminal 500 may determine whether a connection with the manager terminal 100 is established (S450).

If the user terminal 500 determines that the connection with the manager terminal 100 is established, the user terminal 500 may transmit an image being captured in real-time to the manager terminal 100 through the gateway server 400 (S460).

Here, if the user terminal 500 determines that the connection with the manager terminal 100 is established, the user terminal 500 may execute a speaker phone function.

Accordingly, the user may capture an image for explaining the need for remote support while, at the same time, talking on the phone.

Next, the user terminal 500 may receive an image indicating information input by the manager from the manager terminal 100 (S470).

According to the image exchange method for remote support of an embodiment of the present invention, the user terminal 500 and the manager terminal 100 can transmit and receive images one-to-one through a specific gateway server. Accordingly, if the user captures an image of a product, etc. for which remote support is needed and transmits the image to the manager terminal 100, the manager may indicate what needs to be done on a transmitted screen, thereby improving the efficiency of remote support.

While example embodiments of the present invention and their advantages have been described in detail, it should be understood that various changes, substitutions and alterations may be made herein without departing from the scope of the invention.

What is claimed is:

1. An image exchange method for remote support which is performed in a manager terminal, the method comprising:
requesting an authentication server for authentication;
receiving connection information of a gateway server from the authentication server;
connecting to the gateway server based on the received connection information of the gateway server and waiting for remote connection with a user terminal; and
if the remote connection with the user terminal is established, receiving an image from the user terminal through the gateway server.

2. The method according to claim 1, further comprising: after the receiving of the image from the user terminal through the gateway server,
indicating at least one among an input marking, a picture, and a check on the received image, and transmitting an image on which the at least one among the input marking, the picture, and the check is indicated to the user terminal.

3. The method according to claim 1, wherein the requesting of the authentication server for authentication includes transmitting authentication information including at least one of an identification (ID) and a password based on a manager input signal to the authentication server.

4. The method according to claim 1, wherein the image is an image of an object captured in real-time using the user terminal.

5. The method according to claim 1, further comprising: after the receiving of the connection information of the gateway server,
transmitting information on a location from which an application for remote support can be downloaded by a least one method among a message and an e-mail to the user terminal.

6. An image exchange method for remote support which is performed in a user terminal, the method comprising:
launching an application;
requesting an authentication server for authentication through the launched application;
receiving gateway server connection information corresponding to the authentication request from the authentication server;
connecting to a gateway server based on the gateway server connection information; and
transmitting an image captured in real-time to a manager terminal with which a remote connection is established through the gateway server.

7. The method according to claim 6, further comprising: before the launching of the application,
receiving information on a location from which an application for remote support can be downloaded from the manager terminal by a least one method among a message and an e-mail.

8. The method according to claim 7, wherein the requesting of the authentication server for the authentication through the launched application includes transmitting a password input by a user to the authentication server.

9. The method according to claim 6, wherein the receiving of the connection information of the gateway server corresponding to the authentication server includes receiving information including at least one among an IP address and a Port Number of the gateway server from the authentication server.

10. The method according to claim 6, wherein the transmitting of the image captured in real-time to the manager terminal with which the remote connection is established through the gateway server, if the remote connection with the manager terminal is established, includes executing a speaker phone function by the user terminal.

11. The method according to claim 6, further comprising: after the transmitting of the image captured in real-time to the manager terminal with which the remote connection is established through the gateway server,
receiving an image on which at least one among the input marking, the picture, and the check is indicated, from the manager terminal.
